(19) United States
(12) Patent Application Publication
(10) Pub. No.: US 2016/0375650 A1
(43) Pub. Date: Dec. 29, 2016

(54) Towel for Athletes

(71) Applicant: Goecke Rieper GbR, Hamburg (DE)

(72) Inventors: Florian Goecke, Hamburg (DE); Lennart Rieper, Hamburg (DE)

(21) Appl. No.: 14/836,540

(22) Filed: Aug. 26, 2015

(30) Foreign Application Priority Data
Jun. 25, 2015 (DE) 20 2015 103 338.9

(51) Int. Cl. B32B 5/06; B65D 33/25; B65D 30/22; B32B 9/02

(52) U.S. Cl. CPC B32B 5/06; B32B 9/025; B65D 33/2591; B65D 31/12; B32B 2439/40

(57) ABSTRACT

A towel for athletes includes, in accordance with one aspect of the invention, a textile web having a front side section configured as two layers forming a pocket including an opening oriented towards an outer surface of the textile web. In accordance with another aspect of the invention, the towel includes a textile web and a strip attached to one side of the textile web, wherein the section of the strip attached to the textile web has a first magnet, and the free section of the strip has a second magnet, wherein the first magnet and the second magnet are releaseably connected to one other in a configuration configuring the strip as a loop.

### BACKGROUND OF THE INVENTION

The invention relates to a towel for athletes. In particular, the invention relates to a towel for all athletes who wish to practice targeted strength and endurance training in a fitness center.

A towel is an indispensable utensil for strength and endurance training at fitness centers. On the one hand, the training device should be covered with a towel for hygienic reasons; on the other it, it serves to dry off sweat and in pauses between exercises to keep body parts warm that are at risk of cooling down.

It is disadvantageous in known hand towels, for example, that they regularly slide from training devices. The stations usually have no means available for hanging the towel so that it can be set aside between exercises.

In addition to the towel, the exerciser is thus obliged to bring along a sports bag to carry and store the towel when not in use. Personal items, e.g., keys or key cards for entering the fitness center, can also be carried in the sports bag.

A sports towel is indeed already known from DE 20 2010 015 320 U1 that includes a pocket for holding keys or key cards. This solves only some of the problems arising in the fitness center, however.

### SUMMARY OF THE INVENTION

The object of the present invention is therefore to provide a towel that is optimally adapted to the environment of a fitness center and offers maximum comfort to the athlete.

The fundamental idea of the invention is to design a towel such that a plurality of functions appropriate for visiting a fitness center are fulfilled.

According to a first alternative the towel includes a textile web, which includes at one end a section that is configured in two layers, forming a pocket having an opening oriented to the surface of the textile web. This can be achieved, for example, by the textile web being folded and stitched on its longitudinal sides. The resulting rear pocket can thus be slipped over the backrest or bench of a training device so that the towel is secured against slipping and falling from the training device.

For this purpose it is provided in particular that the opening of the pocket extends over the width of the textile web.

This section of the textile web preferably includes an additional pocket having a closing means on the side with the opening of the pocket; this may be used, for example, to carry the identification card for the fitness center, money, keys, or an MP3 player. Providing the additional pocket on the rear side of the textile web determining the total length of the towel ensures that the items held in the additional pocket do not come to rest on the side of the backrest used by the athlete and do not impair sitting comfort.

In particular a zipper is provided as closing means for the additional pocket. This zipper particularly preferably includes a slider with a slider grip that is configured as a hook. Thanks to this design it is possible to hang the towel on a wall hook or a cord, for example a clothesline.

As an alternative solution the towel includes a textile web and a strip attached on one side on the textile web, wherein the section of the strip attached to the textile web has a first magnet, and the free section of the strip has a second magnet. If the first magnet and the second magnet are brought together, this creates a loop that is suitable for hanging the towel on a wall hook or the like. Alternatively in the stretched configuration of the present strip, two magnets are available, which can be attached to the metal parts of the training device so that the towel need not be placed on the floor or in a pocket.

The strip is attached to the towel in particular on one side of the textile web, extending away from the textile web, wherein the side of the textile web is specifically a front side of the textile web.

The length of the strip is particularly preferably dimensioned such that clamping of the other side of the textile web between the magnets is possible. This is preferable in particular if the towel is wrapped around the neck as a scarf: the magnets fix the other end of the towel wrapped around the neck such that the towel protects the neck from cooling down and cannot slip.

The strip is formed in particular from leather, since it is skin-friendly, washable, and durable.

According to a particularly preferable design, the towel includes all features of both above-mentioned alternatives:

Thus the last-named alternative would further be configured such that the textile web includes a section on its one side that is in two layers, which is configured to form a pocket including an opening oriented towards the surface of the textile web.

The opening of the pocket also extends in this case over the entire width of the textile web.

Here also the section preferably includes an additional pocket, including a closing means, on its side with the opening of the pocket, which additional pocket can specifically be closed using a zipper.

It is particularly preferable if the zipper includes a slider including a slider grip, wherein the slider grip is configured as a hook. If the strip is disposed on the front side of the textile web, which front side includes the additional pocket, in this case the towel can be attached for drying on a clothesline using the hook on the zipper and using the strip with the magnets.

### DETAILED DESCRIPTION OF THE DRAWINGS

The invention is explained in more detail with reference to a particularly preferably configured exemplary embodiment depicted in the accompanying drawings:

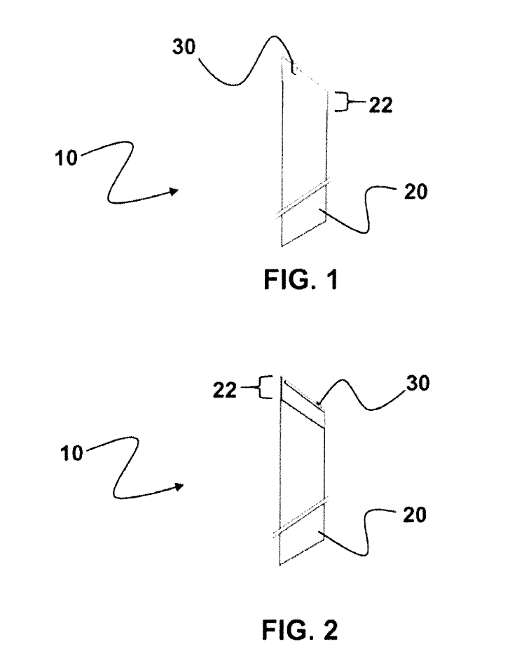

FIG. 1 shows a perspective frontal view of the particularly preferably designed exemplary embodiment according to the invention;

FIG. 2 shows a perspective view of the rear side of the towel from FIG. 1;

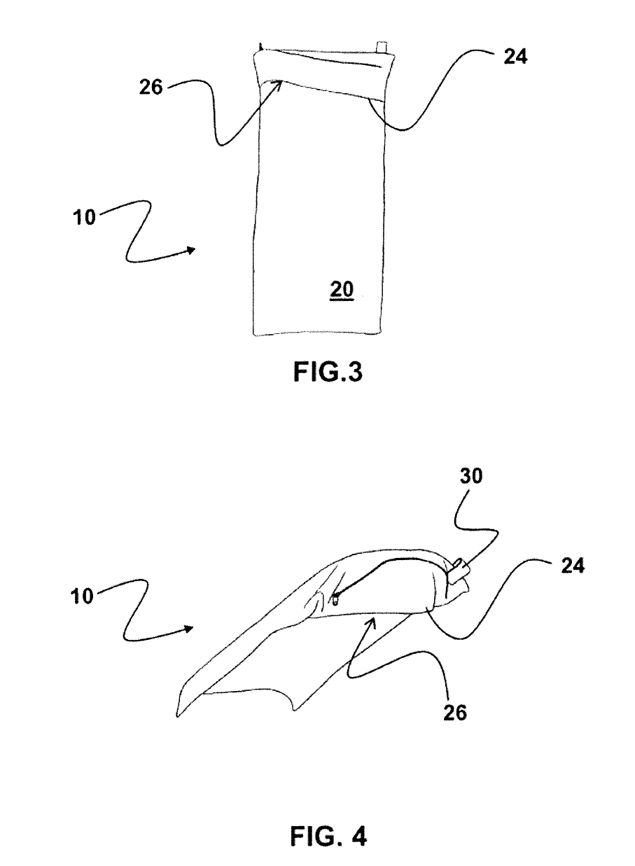

FIG. 3 shows a plan view of the rear side of the particularly preferably designed towel;

FIG. 4 shows a perspective view of the particularly preferably designed towel in preparation for placement on a piece of sports equipment;

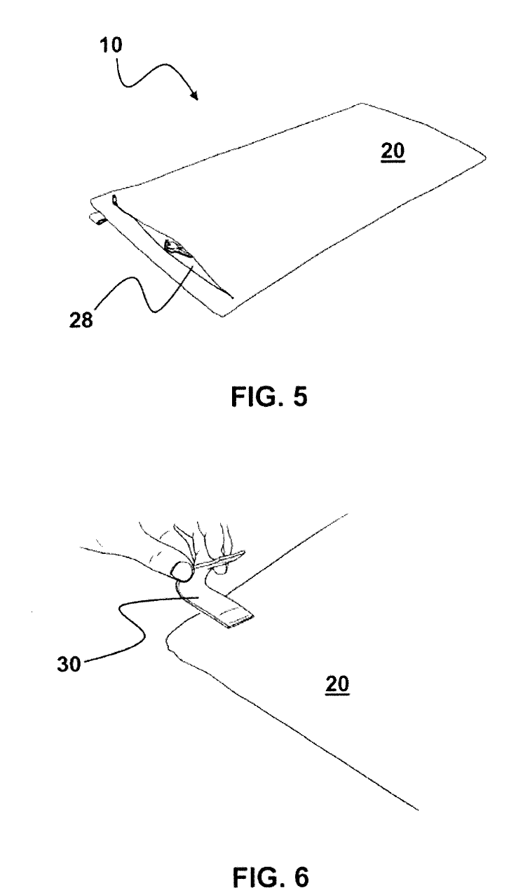

FIG. 5 shows a further perspective view of the rear side of the towel; and

FIG. 6 shows a detail view of the magnet clip attached to one side of the towel.

### DETAILED DESCRIPTION OF THE INVENTION

FIG. 1 shows a perspective frontal view of the particularly preferably designed exemplary embodiment according to the invention. The towel 10 includes a textile web 20, which on its upper front side includes a section 22, which is configured in at least two layers. The strip 30 containing the magnets is also disposed in this region, which strip 30 allows the towel 10 to be hung—on the one hand by configuration as a loop on appropriate wall hooks, and on the other hand by magnetic force on metallic objects, e.g. fitness devices.

FIG. 2 shows a perspective view of the rear side of the towel 10 from FIG. 1. An additional pocket 28, which is clearly visible in FIG. 5 and is closable by a zipper, is located in section 22 on the rear side of the towel 10.

FIG. 3 shows a plan view of the rear side of the particularly preferably designed towel 10. The two-layer design of the section 22, with simultaneous closure of the longitudinal sides inside the section 22, leads to the formation of a pocket 24, whose opening 26 faces the surface of the textile web 20. This allows it to be slipped over the backrest or bench of a training device (not shown), so that the towel 10 cannot fall from the training device.

FIG. 4 shows a perspective view of the particularly preferably designed towel 10 during preparation for placement on a piece of sports equipment—a part of the sports equipment here occupies the space formed by the pocket 24 between the layers of the textile web 22.

FIG. 5 shows a further perspective view of the rear side of the towel 10, in which the additional pocket 28 is clearly visible.

Finally FIG. 6 shows a detail view of the magnet clip 30 attached on one side of the hand towel 10. The strip 30 is attached on one side of the textile web 20, wherein the free end of the strip 30 forms a loop by interaction of the magnets disposed in the two sections of the strip 30. The magnets preferably must be designed to be strong enough that an end of the textile web opposite the strip 30 is clamped between the magnets—the towel 10 can then be used as a scarf, for example, wherein the strip acts as a closing means.

1. A towel comprising a textile web, wherein the textile web has a section on its one front side, which section is configured as two layers, forming a pocket including an opening oriented towards an outer surface of the textile web.

2. The towel according to claim 1, characterized in that the opening of the pocket extends over the width of the textile web.

3. The towel according to claim 1, characterized in that the section has an additional pocket, including a closing means, on its side with the opening of the pocket.

4. The towel according to claim 1, characterized in that the closing means is a zipper.

5. The towel according to claim 4, characterized in that the zipper has a slider with a slider grip, wherein the slider grip is configured as a hook.

6. The towel comprising a textile web and a strip attached to one side of the textile web, wherein the section of the strip attached to the textile web has a first magnet, and the free section of the strip has a second magnet, wherein the first magnet and the second magnet are releaseably connected to one other in a configuration configuring the strip as a loop.

7. The towel according to claim 6, characterized in that the strip is attached on one side of the textile web and extends away from the textile web.

8. The towel according to claim 7, characterized in that the side of the textile web is a front side of the textile web.

9. The towel according to claim 7, characterized in that the length of the strip allows clamping of the other side of the textile web between the magnets.

10. The towel according to claim 6, characterized in that the strip is made of leather.

11. The towel according to claim 6, characterized in that on its front side the textile web has a section that is in two layers and forms a pocket with an opening oriented towards the surface of the textile web.

12. The towel according to claim 11, characterized in that the opening of the pocket extends over the width of the textile web.

13. The towel according to claim 11, characterized in that the section includes an additional pocket having an opening means on its side with the opening of the pocket.

14. The towel according to claim 11, characterized in that the closing means is a zipper.

15. The towel according to claim 14, characterized in that the zipper includes a slider with a slider grip, wherein the slider grip is configured as a hook.

16. The towel according to claim 11, characterized in that the strip is disposed on the front side of the textile web with the pocket.
